(19) United States
(12) Patent Application Publication
(10) Pub. No.: US 2026/0186132 A1
(43) Pub. Date: Jul. 2, 2026

(54) RADAR SYSTEM, RADAR INFORMATION SHARING METHOD, AND NON-TRANSITORY COMPUTER READABLE MEDIUM

(71) Applicant: Furuno Electric Co., Ltd., Nishinomiya (JP)

(72) Inventors: Kazuya NAKAGAWA, Amagasaki (JP); Daisuke MATSUMOTO, Kobe (JP)

(21) Appl. No.: 19/545,306

(22) Filed: Feb. 20, 2026

Related U.S. Application Data
(63) Continuation of application No. PCT/JP2024/026410, filed on Jul. 24, 2024.

(30) Foreign Application Priority Data
Aug. 23, 2023 (JP) 2023-135467

(51) Int. Cl. G01S 13/937; G01S 7/10; G01S 7/41; G01S 13/58; G01S 13/72

(52) U.S. Cl. CPC G01S 13/937; G01S 7/10; G01S 7/41; G01S 13/589; G01S 13/726

(57) ABSTRACT

A radar system includes: a radar sensor, receiving reflected waves of radio waves generated around a vessel and generating echo data; a generation unit, generating target data including a position and a velocity of a target present around the vessel based on the echo data; a selection unit, selecting a display target and a non-display target from among the target; and an output unit, setting an output priority of target data of the display target over an output priority of target data of the non-display target, and outputting the target data.

### CROSS-REFERENCE TO RELATED APPLICATION

The present application is a continuation of PCT/JP2024/026410, filed on Jul. 24, 2024, and is related to and claims priority from Japanese patent application no. 2023-135467, filed on Aug. 23, 2023. The entire contents of the aforementioned applications are hereby incorporated by reference herein.

### BACKGROUND

### Technical Field

The invention relates to a radar system, a radar information sharing method, and a non-transitory computer readable medium.

### Description of Related Art

Patent Document 1 (Japanese Patent Application Laid-Open Publication No. H10-253749) discloses a radar signal recording and playback device having a recording system that records radar video obtained from a radar device on a recording medium, and a playback system that plays back the radar video from the recording medium.

Target data generated by a radar system mounted on a vessel is output to a display unit that displays radar images and the like, or to other ships or onshore devices through maritime communication. However, uniformly sharing all target data may often be wasteful.

The invention provides a radar system, a radar information sharing method, and a program capable of sharing required target data.

### SUMMARY

To solve the above issue, a radar system according to an aspect of the invention includes: a radar sensor, receiving reflected waves of radio waves generated around a vessel and generating echo data; a generation unit, generating target data including a position and a velocity of a target present around the vessel based on the echo data; a selection unit, selecting a display target and a non-display target from among the target; and an output unit, setting an output priority of target data of the display target over an output priority of target data of the non-display target, and outputting the target data. Accordingly, it is possible to preferentially share the target data of the display target.

In the above aspect, it may also be that the radar system further includes: an acquisition unit, acquiring vessel data including a velocity of the vessel; and a calculation unit, calculating risk data representing a risk that the vessel collides with the target based on the vessel data and the target data. The output unit may set an output priority of risk data related to the display target over an output priority of risk data related to the non-display target and output the risk data that are sequentially calculated. Accordingly, it is possible to preferentially share the risk data related to the display target.

In the above aspect, it may also be that the output unit changes the output priorities of the target data of the display target, the target data of the non-display target, the risk data related the display target, and the risk data related to the non-display target according to a type of an output destination. Accordingly, it is possible to share the target data and the risk data by using the output priority suitable for the output destination.

In the above aspect, it may also be that the output unit switches the output priority of the target data of the non-display target and the output priority of the risk data related to the display target according to a type of an output destination. Accordingly, it is possible to possible to share the target data and the risk data by using the output priority suitable for the output destination.

In the above aspect, it may also be that, in a case where an output destination i outside the vessel, the output unit sets in order, from a highest output priority, the target data of the display target, the target data of the non-display target, the risk data related to the display target, and the risk data related to the non-display target. Accordingly, it is possible to share the target data and risk data with priority given to the target data.

In the above aspect, it may also be that in a case where an output destination is display unit provided at the vessel, the output unit sets in order, from a highest output priority, the target data of the display target, the risk data related to the display target, the target data of the non-display target, and the risk data related to the non-display target. Accordingly, it is possible to share the target data and the risk data with priority given to the display data.

In the above aspect, it may also be that the display unit displays a velocity symbol representing a velocity of the display target and a collision risk area related to the display target. Accordingly, it is possible to display the velocity symbol and the collision risk area by using the display data output preferentially.

In the above aspect, it may also be that the output unit sets an output frequency of data with a low output priority to be lower than an output frequency of data with a high output priority. Accordingly, it is possible to change the output frequency according to the output priority.

In the above aspect, it may also be that the output unit sets a compression ratio data with a low output priority to be higher than a compression ratio of data with a high output priority. Accordingly, it is possible to change the compression ratio according to the output priority.

In the above aspect, it may also be that the selection unit selects, as the display target, a target whose risk of collision is equal to or higher than a particular level based on the risk data. Accordingly, it is possible to select a target with a collision risk as the display target.

In the above aspect, it may also be that the radar system further includes an identification unit, identifying a display target range displayed in the image, and the selection unit selects, as the display target, a target included in the display target range. Accordingly, it is possible to select the target included in the display target range as the display target.

In the above aspect, it may also be that the selection unit selects, as the display target, a target instructed by a user. Accordingly, it is possible to select a target instructed by the user as the display target.

Also, a radar information sharing method according to another aspect includes: generating echo data by using a radar sensor receiving reflected waves of radio waves generated around a vessel; generating target data including a position and a velocity of a target present around the vessel based on the echo data; selecting a display target and a non-display target from among the target; and setting an output priority of target data of the display target over an output priority of target data of the non-display target, and outputting the target data. Accordingly, it is possible to preferentially share the target data of the display target.

Also, a program according to another aspect causes a computer to execute: generating echo data by using a radar sensor receiving reflected waves of radio waves generated around a vessel; generating target data including a position and a velocity of a target present around the vessel based on the echo data; selecting a display target and a non-display target from among the target; and setting an output priority of target data of the display target over an output priority of target data of the non-display target, and outputting the target data. Accordingly, it is possible to preferentially share the target data of the display target.

### BRIEF DESCRIPTION OF THE DRAWINGS

FIG. 1 is a diagram showing a configuration example of a radar system.

FIG. 2 is a diagram showing a configuration example of processing circuitry.

FIG. 3 is a diagram showing an example of a target management database.

FIG. 4 is a diagram showing an example of a risk management database.

FIG. 5 is a diagram showing an example of a display management database.

FIG. 6 is a diagram showing an example of echo data.

FIG. 7 is a diagram showing a calculation example of a collision risk area.

FIG. 8 is a diagram showing a calculation example of CPA.

FIG. 9 is a diagram showing a selection example of targets for display.

FIG. 10 is a diagram showing a display example of a radar image.

FIG. 11A is a diagram showing a display example of symbols.

FIG. 11B is a diagram showing a display example of symbols.

FIG. 11C is a diagram showing a display example of symbols.

FIG. 12 is a diagram showing a display example of a chart image.

FIG. 13 is a diagram showing a procedure example of a radar display method.

FIG. 14 is a diagram showing an example of output priority.

FIG. 15 is a diagram showing an example of output priority.

FIG. 16 is a diagram showing a procedure example of a radar information sharing method.

FIG. 17 is a diagram showing a configuration example of a display control unit.

FIG. 18 is a diagram showing an example of a virtual three-dimensional space.

FIG. 19 is a diagram showing an example of a three-dimensional image.

FIG. 20A is a diagram showing a setting example of a virtual camera.

FIG. 20B is a diagram showing an example of a field of view of a virtual camera.

FIG. 21A is a diagram showing a setting example of a virtual camera.

FIG. 21B is a diagram showing an example of a field of view of a virtual camera.

FIG. 22A is a diagram showing a setting example of a virtual camera.

FIG. 22B is a diagram showing an example of a field of view of a virtual camera.

FIG. 23A is a diagram showing a setting example of a virtual camera.

FIG. 23B is a diagram showing an example of a field of view of a virtual camera.

FIG. 24 is a diagram showing a procedure example of a radar display method.

### DESCRIPTION OF THE EMBODIMENTS

Hereinafter, embodiments of the invention will be described with reference to the drawings. In the specification and each drawing, elements similar to those described above with respect to previously shown drawings are denoted by the same reference numerals, and detailed descriptions may be appropriately omitted.

### System Overview

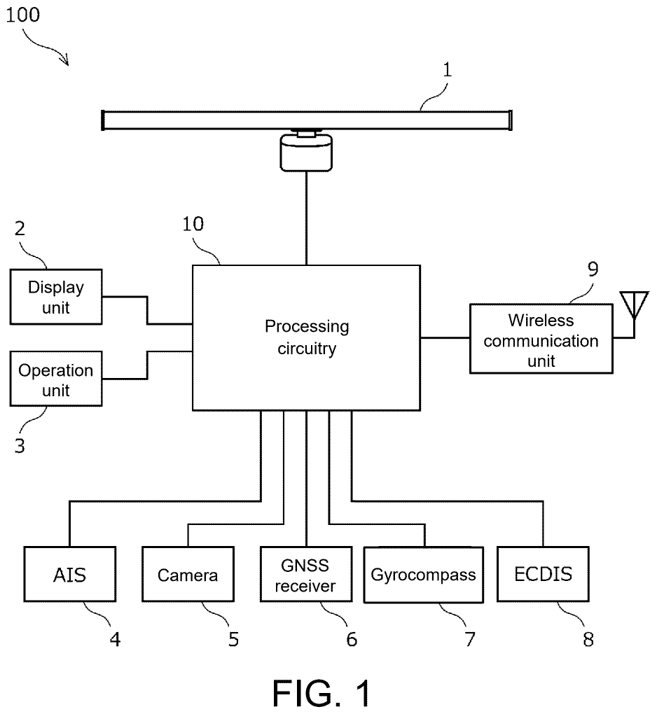

FIG. 1 is a block diagram showing a configuration example of a radar system 100. In the following description, a vessel equipped with the radar system 100 is referred to as “own ship,” and other vessels are referred to as “other ships.” The radar system 100 includes a radar sensor 1, a display unit 2, an operation unit 3, and processing circuitry 10.

The radar sensor 1 emits radio waves around the own ship, receives reflected waves thereof, and generates echo data based on received signals. The radar sensor 1 includes an antenna, a transmission and reception unit, and a signal processing unit.

The received signal from the antenna passes through a frequency conversion and amplification circuit and a wave detection circuit included in the transmission and reception unit, undergoes signal processing in the signal processing unit, and is supplied to the processing circuitry 10 as a digital signal. In the signal processing, echo data is processed to suppress unnecessary echoes caused by waves and the like, making echoes of targets such as other ships more easily identifiable.

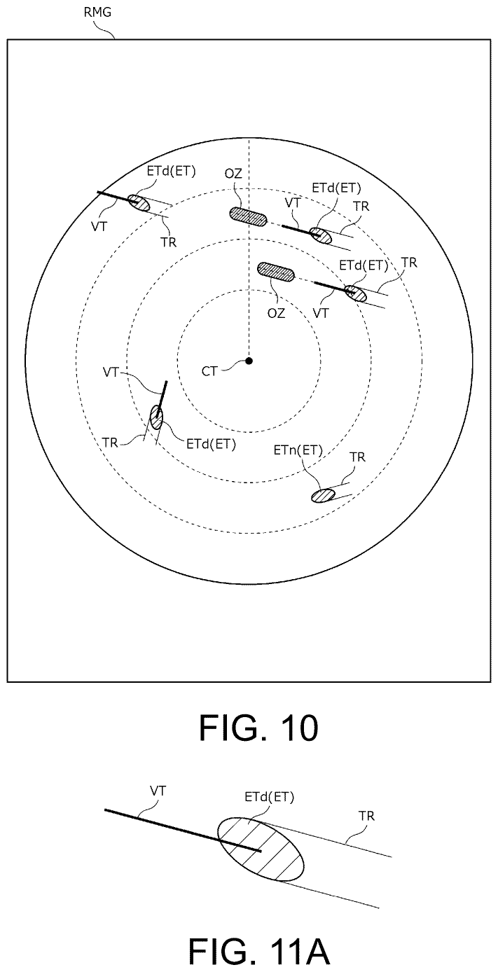

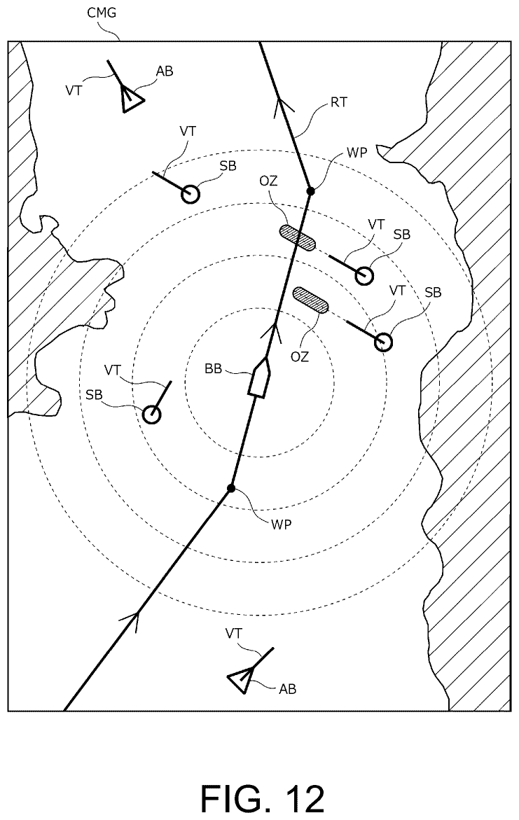

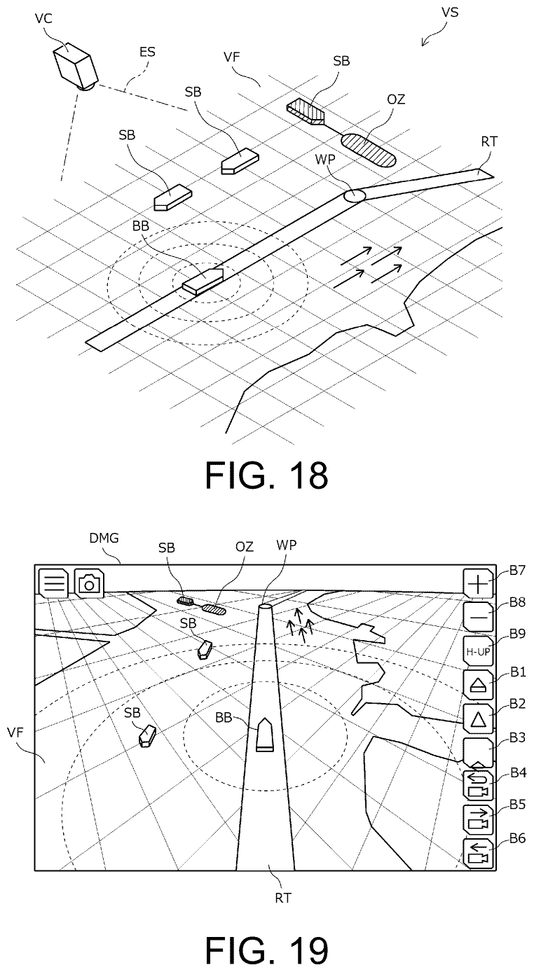

The display unit 2 is, for example, a liquid crystal display device or an organic EL display device. The display unit 2 displays a radar image RMG (see FIG. 10) generated by the processing circuitry 10. The display unit 2 may also display a chart image CMG (see FIG. 12) or a three-dimensional image DMG (see FIG. 19).

The operation unit 3 is, for example, a pointing device such as a trackball. The operation unit 3 may also be a touch panel provided on the screen of the display unit 2. A user operating the operation unit 3 inputs an instruction position within the screen of the display unit 2.

The processing circuitry 10 includes a computer that includes a CPU, a RAM, a ROM, non-volatile memory, an input and output interface, and the like. The CPU of the processing circuitry 10 executes information processing according to a program loaded from the ROM or non-volatile memory into the RAM.

The program may be supplied via an information storage medium such as an optical disc or a memory card, or may be supplied via a communication network such as the Internet or LAN.

In addition, the radar system 100 further includes an automatic identification system (AIS) 4, a camera 5, a global navigation satellite system (GNSS) receiver 6, a gyrocompass 7, a n electronic chart display and information system (ECDIS) 8, and a wireless communication unit 9. The devices are capable of conducting network communication with the processing circuitry 10 through a communication network such as a LAN.

The AIS 4 receives AIS data from other ships present around the own ship or from land-based control. In addition to AIS, a VHF data exchange system (VDES) may also be used. The AIS data includes the identification codes, ship names, positions, courses, ship velocities, ship types, hull lengths, and destinations of other ships.

The camera 5 is a digital camera that captures images of the exterior from the own ship and generates image data. The camera 5 is installed, for example, on the bridge of the own ship facing the bow direction. The camera 5 is, for example, a so-called PTZ camera having a pan and tilt function and an optical zoom function.

The camera 5 may include an image recognition unit that estimates in-image positions and types of targets such as other ships included in the captured image by using an object detection model. The image recognition unit is not limited to the camera 5, and may be realized in other devices such as the processing circuitry 10.

The GNSS receiver 6 detects the position of the own ship based on radio waves received from a GNSS. The gyrocompass 7 detects the bow direction of the own ship. In addition to the gyrocompass, a GPS compass may also be used.

The ECDIS 8 acquires the position of the own ship from the GNSS receiver 6 and displays the position of the own ship on an electronic chart. The ECDIS 8 also displays the scheduled route of the own ship on the electronic chart. In addition to the ECDIS, a GNSS plotter may also be used.

The wireless communication unit 9 includes a wireless facility that realizes satellite communication. The wireless communication unit 9 also includes a wireless facility that realizes wireless communication using, for example, ultra short waves, very short waves, short waves, medium short waves, or medium waves.

In the embodiment, the display image generated by the processing circuitry 10 is displayed on the display unit 2. However, the invention is not limited thereto. The display image may be displayed on a display unit of another device such as the ECDIS 8.

embodiment, the radar system 100 is mounted on the own ship and used to monitor targets such as other ships present around the own ship. However, the invention is not limited thereto. The radar system 100 may also be installed, for example, at land-based control and used to monitor ships navigating in a controlled sea area.

### Configuration of Processing Circuitry

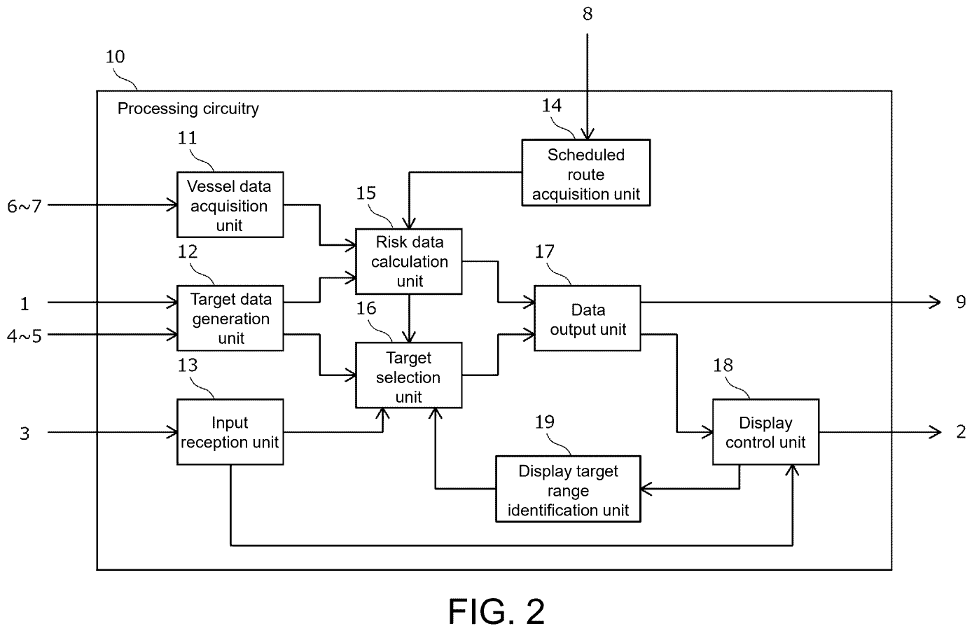

FIG. 2 is a block diagram showing a configuration example of the processing circuitry 10 of the radar system 100. FIG. 3 to FIG. 5 are diagrams showing content examples of databases (DBs) constructed in the memory of the processing circuitry 10.

As shown in FIG. 2, the processing circuitry 10 includes a ship data acquisition unit 11, a target data generation unit 12, an input reception unit 13, a scheduled route acquisition unit 14, a risk data calculation unit 15, a target selection unit 16, a data output unit 17, a display control unit 18, and a display target range identification unit 19.

The functional units are realized by the CPU of the processing circuitry 10 executing information processing according to a program. Some of the functional units may be realized in other devices such as the ECDIS 8.

The ship data acquisition unit 11 acquires vessel data including the position and the velocity of the own ship. The velocity is a vector quantity represented by ship velocity and course, and the ship velocity is a scalar quantity.

Specifically, the ship data acquisition unit 11 sequentially acquires the positions of the own ship detected by the GNSS receiver 6, and calculates the velocity of the own ship from temporal changes in the positions of the own ship. However, the invention is not limited thereto. The ship velocity of the own ship may be acquired from a ship velocity indicator (not shown), and the course of the own ship may be acquired from the gyrocompass 7.

The target data generation unit 12 generates target data including positions and velocities of targets present around the own ship, based on echo data sequentially generated by the radar sensor 1. The target data is the so-called target tracking (TT) data.

The target data generation unit 12 may further use, as target data, AIS data received by the AIS 4 or identification data identified from images captured by the camera 5, in addition to the target data (TT data) based on echo data.

The target data generation unit 12 registers the generated target data in a target management DB (see FIG. 3) for managing targets.

As shown in FIG. 3, the target management DB includes fields such as “target ID”, “position”, “velocity” , “course”, and “elapsed time”. The “target ID” is an identifier assigned to a target.

“Position” represents the position of the target. The position of the target is a relative position represented by azimuth and distance with respect to the own ship. The position of the target may be converted to an absolute position using the position of the own ship detected by the GNSS receiver 6.

“Velocity” represents the ship velocity of the target. “Course” represents the course of the target. The velocity and the course of the target are estimated from changes in the position of the target through time. “Elapsed time” represents the elapsed time since the target is detected.

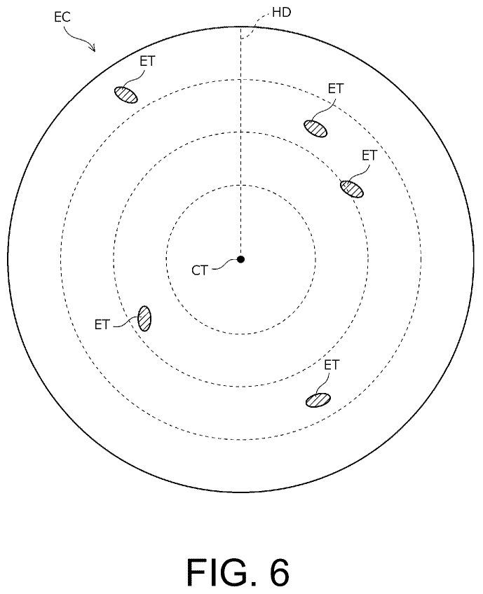

FIG. 6 is a diagram showing an example of echo data EC generated by the radar sensor 1. The echo data EC is generated each time the antenna makes one rotation. Targets such as other ships are identified from the echo data EC for several scans in the past.

In the same figure, echo data EC in the format of plan position indicator (PPI) is shown, which represents the relationship between distance and azimuth radially with the position of the own ship as the center, but the format is not limited thereto, and may be in a RHI (Range Height Indicator) format with azimuth as the horizontal axis and distance on the vertical axis.

In the echo data EC, echo points ET corresponding to targets appear. The center CT of the echo data EC represents the position of the own ship. A line segment HD extending upward from the center CT represents the bow direction of the own ship.

As shown in FIG. 2, the input reception unit 13 receives an operation input of a user from the operation unit 3. The operation input of the user is, for example, an operation input for indicating an echo point ET in a radar image RMG (see FIG. 10), or an operation input for changing a display target range of a chart image CMG (see FIG. 12) or a three-dimensional image DMG (see FIG. 19).

The scheduled route acquisition unit 14 acquires the scheduled route of the own ship from the ECDIS 8. The scheduled route is, for example, a planned route to a destination based on a navigation plan. However, the invention is not limited thereto. The scheduled route acquisition unit 14 may also calculate an avoidance route for avoiding a collision in the case where the collision risk calculated by the risk data calculation unit 15 becomes equal to or higher than a particular level.

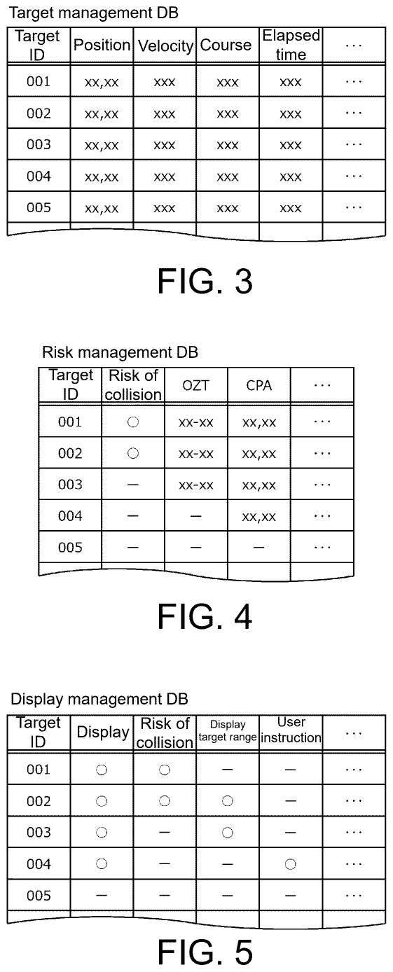

The risk data calculation unit 15 calculates risk data representing the risk of collision between the own ship and a target based on the vessel data and the target data. The risk data calculation unit 15 registers the calculated risk data in a risk management DB (see FIG. 4).

Specifically, the risk data calculation unit 15 calculates, as risk data, a collision risk area where the risk of collision between the own ship and the target exceeds the particular level. The collision risk area is, for example, an obstacle zone by target (OZT). Additionally, a predict area of danger (PAD) or a dangerous area of collision (DAC) may also be used.

Also, the risk data calculation unit 15 may calculate a distance to closest point of approach (DCPA) and time to closest point of approach (TCPA) of a CPA collision alarm as risk data. Additionally, for example, a bow crossing range) and a bow crossing time (BCT) may be used. Also, the risk data calculation unit 15 may simply calculate the current distance from the own ship to the target as risk data.

Furthermore, the risk data calculation unit 15 may calculate the risk data in the case where the own ship navigates the scheduled route acquired by the scheduled route acquisition unit 14. For example, the risk data calculation unit 15 may calculate the risk of collision between the own ship and a target for each of multiple legs constituting the scheduled route, and integrate the risks as risk data.

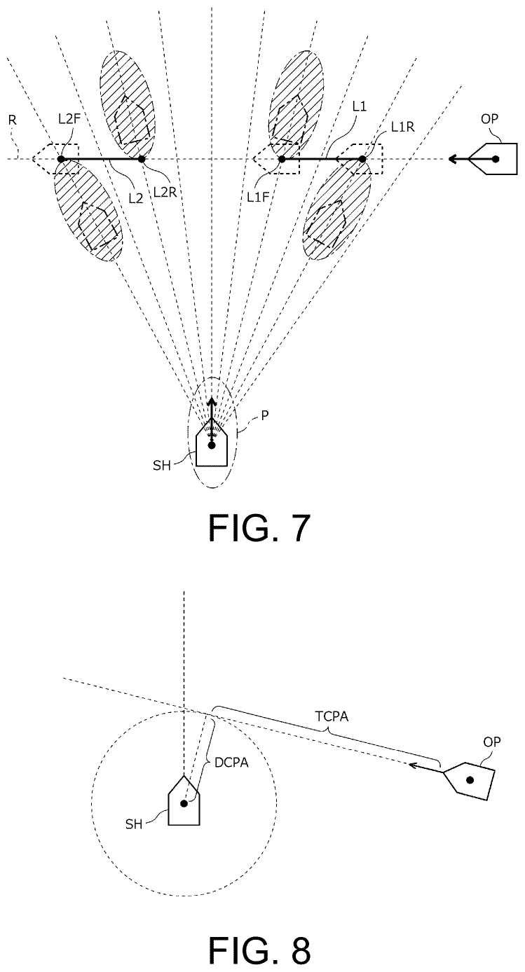

FIG. 7 is a diagram showing a calculation example of collision risk areas. The risk data calculation unit 15 calculates, as collision risk areas, sections L1 and L2 of a predicted route R of a target OP where the risk of collision between an own ship SH and the target OP is above a particular level, assuming that the own ship SH changes course in an arbitrary direction to navigate and crosses the predicted route R of the target OP.

The risk data calculation unit 15 calculates the separation distance between the predicted position of the own ship SH and the predicted position of the target OP at each time point, and calculates the risk of collision based on the separation distance and the vessel size. The risk data calculation unit 15 extracts the position closest to the predicted position of the target OP at the same time point from within a circle representing the predicted position of the own ship SH at a certain time point, and calculates the separation distance.

For example, the risk data calculation unit 15 identifies the risk sections L1 and L2 as having a collision risk equal to or above a threshold in the case where an alert region P set around the own ship SH overlaps with the point representing the predicted position of the target OP. Hereinafter, the traveling direction of the target OP is also referred to as forward, and the opposite direction as backward.

For the first risk section L1 located on the rear side between the two risk sections L1 and L2, a backend L1R of the first risk section L1 becomes a position where the frontend of the alert region P of the own ship SH contacts a point representing the predicted position of the target OP. The frontend L1F of the first risk section L1 becomes a position where the backend of the alert region P of the own ship SH contacts a point representing the predicted position of the target OP.

On the other hand, for the second risk section L2 located on the front side between the two risk sections L1 and L2, a backend L2R of the second risk section L2 becomes a position where the backend of the alert region P of the own ship SH contacts a point representing the predicted position of the target OP. A frontend L2F of the second risk section L2 becomes a position where the frontend of the alert region P of the own ship SH contacts a point representing the predicted position of the target OP.

The range between the first risk section L1 and the second risk section L2 becomes a range where the own ship SH crosses in front of the target OP. On the other hand, the range behind the first risk section L1 and the range in front of the second risk section L2 become ranges where the own ship SH crosses behind the target OP. In the case where the own ship SH crosses the front of the target OP, more attention is required that that to the case where the own ship SH crosses behind the target OP.

However, the invention is not limited thereto. The risk data calculation unit 15 may determine that the collision risk is equal to or above the threshold, for example, in the case where the region of the own ship SH or the alert region P set around the own ship SH overlaps with the region of the target OP or an alert region set around the target OP.

Also, the risk data calculation unit 15 may determine that the collision risk is equal to or above a threshold, for example, in the case where the separation distance between a point representing the predicted position of the own ship SH and a point representing the predicted position of the target OP is equal to or below a threshold.

FIG. 8 is a diagram showing a calculation example of DCPA and TCPA. DCPA is the distance when the target OP is closest to the own ship SH, and TCPA is the time until the target is closest to the own ship SH.

As shown in FIG. 4, the risk management DB includes fields such as “target ID,” “collision risk,” “OZT,” and “CPA.” “OZT” represents the position of the collision risk area. Specifically, “OZT” represents the range from the start point to the end point of the collision risk area. “CPA” represents the values of DCPA and TCPA.

“Collision risk” represents whether the risk of collision with the own ship is equal to or above a particular level. For example, in the case where a collision risk area is present on the bow line of the own ship or on the scheduled route, or in the case where both DCPA and TCPA fall below thresholds, it is determined that the risk of collision with the own ship is equal to or above a particular level.

As shown in FIG. 2, the target selection unit 16 selects a display target and a non-display target from among the targets detected by the radar sensor 1. The target selection unit 16 registers the selection results in the display management DB (see FIG. 5).

Specifically, the target selection unit 16 selects a target with a collision risk equal to above a particular level as the display target based on the risk data calculated by the risk data calculation unit 15. For example, a target having a collision risk area on the bow line of the own ship or on the scheduled route, or a target in which both DCPA and TCPA fall below thresholds, is selected as the display target.

Also, the target selection unit 16 may select a target for which a collision risk area is calculated as the display target. For example, all targets for which collision risk areas have been calculated within a range where the distances from the own ship SH are equal to or below the particular level are selected as the display targets.

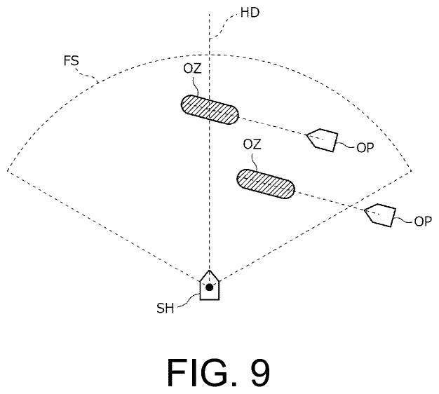

Also, as shown in FIG. 9, the target selection unit 16 may select a target for which a collision risk area OZ is calculated within a particular range FS determined according to the traveling direction of the own ship as the display target. The particular range FS is, for example, a fan-shaped range centered on the bow direction HD, in which the distance from the own ship SH is equal to or less than a particular threshold.

The particular range FS may be changed according to the maneuvering performance of the own ship SH. For example, to set the particular range FS according to the maneuvering performance of the own ship SH, the particular range FS may be narrowed as the own ship SH is larger or the ship velocity is higher, and the particular range FS may be widened as the own ship SH is smaller or the ship velocity is lower.

Furthermore, the target selection unit 16 may select a target with a collision risk equal or higher than a particular level as the display target, and then further select a target within a particular distance from the selected target as the display target to gradually expand the display targets.

The target selection unit 16 selects a target that is currently or will be included in the display target range identified by the display target range identification unit 19 as the display target. The display target range identification unit 19 identifies a display target range corresponding to an image generated by the display control unit 18 from around the own ship. Details of the identification of the display target range will be described later.

The target selection unit 16 selects a target instructed by the user as the display target based on the user's operation input received by the input reception unit 13. For example, in the case where there is an operation input for instructing an echo point ET in the radar image RMG (see FIG. 10) displayed on the display unit 2, the target corresponding to the echo point ET is selected as the display target.

As shown in FIG. 5, the display management DB includes fields such as “target ID”, “display”, “collision risk”, “display target range”, and “user instruction”.

“Collision risk” represents whether the target is selected as the display target based on risk data. “Display target range” represents whether the target is selected as the display target based on the display target range. “User instruction” represents whether the target is selected as the display target by user instruction.

“Display” represents whether the target is a display target. That is, a white circle in “display” indicates that the target is selected as a display target in any of “Collision risk”, “Display target range”, and “User instruction”.

As shown in FIG. 2, the data output unit 17 outputs the target data generated by the target data generation unit 12 and selected by the target selection unit 16 as either for display or non-display, and the risk data calculated by the risk data calculation unit 15, to the wireless communication unit 9 and the display unit 2. Details of the output of target data and risk data will be described later.

The display control unit 18 generates a display image such as a radar image RMG (see FIG. 10) or a chart image CMG (see FIG. 12) based on the target data and the risk data output by the data output unit 17, and displays the image on the display unit 2.

FIG. 10 is a diagram showing a display example of the radar image RMG. The radar image RMG is an image based on the echo data EC (see FIG. 6) and includes echo points ET corresponding to targets. A trajectory TR representing past movement of the target is added to the echo point ET.

Here, the echo points ET are classified into echo points ETd of display targets selected by the target selection unit 16 and echo points ETn of non-display targets.

The display control unit 18 displays a velocity symbol VT representing the velocity of the display target at an in-image position within the radar image RMG corresponding to the actual position of the display target. That is, the display control unit 18 adds the velocity symbol VT to the echo point ETd of the display target, and does not add the velocity symbol VT to the echo point ETn of the non-display target.

Also, the display control unit 18 displays the collision risk region OZ related to the display target at the in-image position within the radar image RMG corresponding to the actual position of the collision risk region identified by the risk data calculation unit 15. The collision risk region OZ is displayed ahead of the velocity symbol VT of the echo point ETd of the display target.

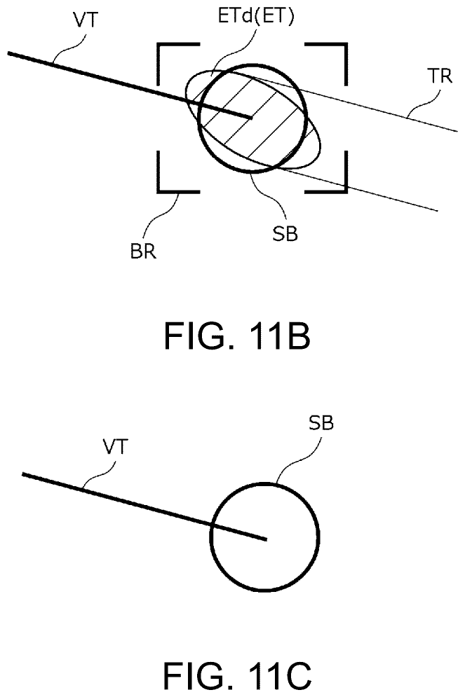

As shown in FIG. 11A, the velocity symbol VT is arranged by setting the echo point ETd as the start point and setting a length corresponding to the ship velocity of the display target and an orientation corresponding to the course.

Also, as shown in FIG. 11B, in addition to the velocity symbol VT, target symbols SB, BR representing the position of the display target may be further displayed. For example, the circular target symbol SB may be displayed to overlap with the echo point ETd, or the bracket-shaped target symbol BR may be displayed to surround the echo point ETd.

Also, as shown in FIG. 11C, it may also be that only the velocity symbol VT and the target symbol SB are displayed without displaying the echo point ETd and the trajectory TR.

FIG. 12 is a diagram showing a display example of the chart image CMG. The chart image CMG is an image based on an electronic chart. The chart image CMG may be a north-up display in which the north direction corresponds to the upward direction of the image, or may be a head-up display in which the bow direction of the own ship corresponds to the upward direction of the image.

The chart image CMG includes an own ship symbol BB representing the position of the own ship, a scheduled route RT of the own ship, and waypoints WP. Also, the chart image CMG further includes the target symbols SB, the velocity symbols VT, and the collision risk regions OZ similar to those described above.

The display control unit 18 displays the target symbol SB and the velocity symbol VT of the display target at an in-image position within the chart image CMG corresponding to the actual position of the display target. Also, the display control unit 18 displays the collision risk region OZ related to the display target at an in-image position within the chart image CMG corresponding to the actual position of the collision risk region.

Also, the display control unit 18 may further display the target symbols AB and the velocity symbols VT based on other target data such as AIS data.

The display control unit 18 changes the display target range of the chart image CMG in response to the user's operation input received by the input reception unit 13. The change in the display target range is, for example, the parallel movement or enlargement or reduction of the display target range. Also, in the case of the head-up display, the display target range may change according to the traveling direction of the own ship.

The display target range of the chart image CMG is identified by the display target range identification unit 19 and notified to the target selection unit 16. The display target range refers to the actual range corresponding to the range within the chart displayed in the chart image CMG. When the display target range is changed, the target selection unit 16 selects the targets included in the changed display target range as the display targets.

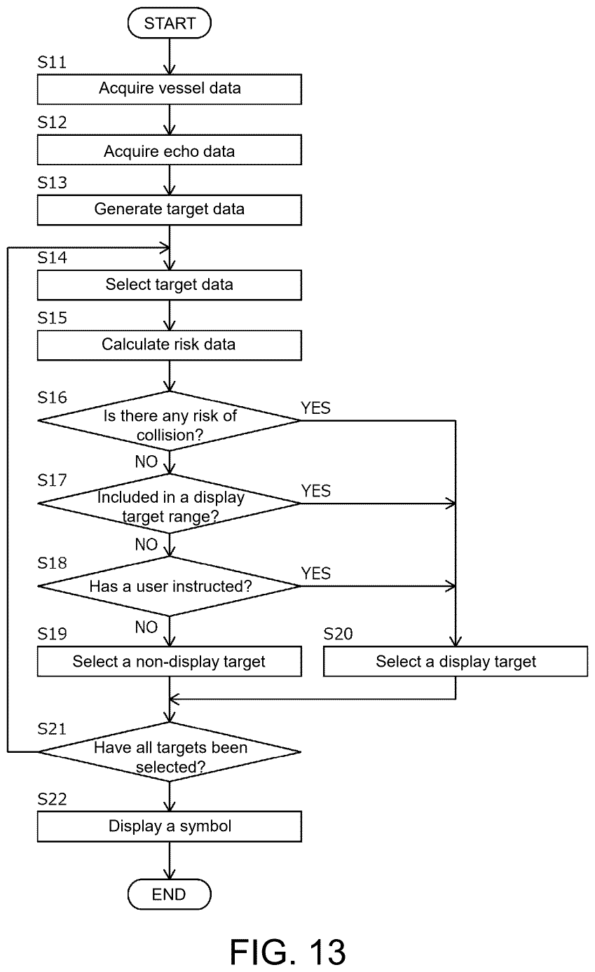

FIG. 13 is a diagram showing a procedure example of a radar display method realized in the radar system 100. The processing circuitry 10 of the radar system 100 periodically executes the information processing shown in the figure according to a program.

First, the processing circuitry 10 acquires vessel data including the position and the velocity of the own ship (S11, a process as the ship data acquisition unit 11).

Next, the processing circuitry 10 acquires the echo data EC (see FIG. 6) generated by the radar sensor 1 (S12), and generates the target data including the positions and the velocities of the target based on the echo data EC of several scans (S13, a process as the target data generation unit 12).

Next, the processing circuitry 10 selects one target data from the multiple target data that are generated (S14), and calculates risk data based on the vessel data and the target data (S15, risk data calculation unit 15).

Next, based on the calculated risk data, in the case where the collision risk between the own ship and the target is equal to or above a particular level (S16: YES), the processing circuitry 10 selects the target as the display target (S20, a process as the target selection unit 16).

Also, in the case where a target is included in the display target range of a display image such as the radar image RMG (see FIG. 10) displayed on the display unit 2 (S17: YES), the processing circuitry 10 selects the target as the display target (S20, a process as the target selection unit 16).

Also, in the case where a target is instructed by a user on the display image such as the radar image RMG (see FIG. 10) displayed on the display unit 2 (S18: YES), the processing circuitry 10 selects the target as the display target (S20, a process as the target selection unit 16).

On the other hand, in the case where the collision risk between the own ship and the target is below a particular level (S16: NO), when the target is not included in the display target range (S17: NO), and when the target is not instructed by the user (S18: NO), the processing circuitry 10 selects the target as a non-display target (S19, a process as the target selection unit 16).

The processing circuitry 10 repeats the processes of S14-S20 described above until the selection of all targets is completed (S21).

After that, the processing circuitry 10 displays the target symbol SB, the velocity symbol VT, and the collision risk area OZ of the display target on a display image such as the radar image RMG (see FIG. 10) (S22, a process as the display control unit 18). Through the above, a series of processes for symbol display is completed.

### Data Output

Hereinafter, specific examples of data output by the data output unit 17 will be described. As shown in FIG. 2, the data output unit 17 outputs sequentially generated target data and risk data to the wireless communication unit 9 and the display unit 2.

The wireless communication unit 9 transmits the target data and the risk data to a device outside the own ship, for example, on land or on other ships. As described above, the display unit 2 displays a display image such as the radar image RMG (see FIG. 10) based on the target data and risk data.

The data output unit 17 outputs the target data by setting the output priority of the target data for the display target to be higher than the target data for the non-display target. Additionally, the data output unit 17 outputs the risk data by setting the output priority of risk data related to the display target to be higher than the risk data related to non-display targets.

For example, the output priority corresponds to the output frequency. The higher the output priority, the higher the data output frequency, and the lower the output priority, the lower the data output frequency. The data output unit 17 makes the output frequency of data with a low output priority lower than the output frequency of data with a high output priority.

The output frequency is the frequency of including the target data or risk data the in t data sets that are transmitted periodically. For example, the output frequency may be a time-based frequency such as once every few seconds, few minutes, or few tens of minutes, or it may be a count-based frequency such as once every few times or few tens of times.

Additionally, the output priority may correspond to a compression ratio of data. The higher the output priority, the lower the compression ratio of data, and the lower the output priority, the larger the compression ratio of data. The data output unit 17 makes the compression ratio of data with a low output priority higher than the compression ratio of data with a high output priority.

The compression ratio of data is also referred to as the degree of data amount reduction or the degree of data thinning. For example, in target data, items other than position and velocity may be reduced, and in risk data, items where the distance or time until collision or approach is above particular may be deleted.

The data output unit 17 changes the output priorities of the target data for the display target, the target data for the non-display target, the risk data related to the display target, and the risk data related to the non-display target according to the type of output destination. That is, the output priority of the target data for the non-display target and the output priority of the risk data related to the display target are switched according to the type of output destination.

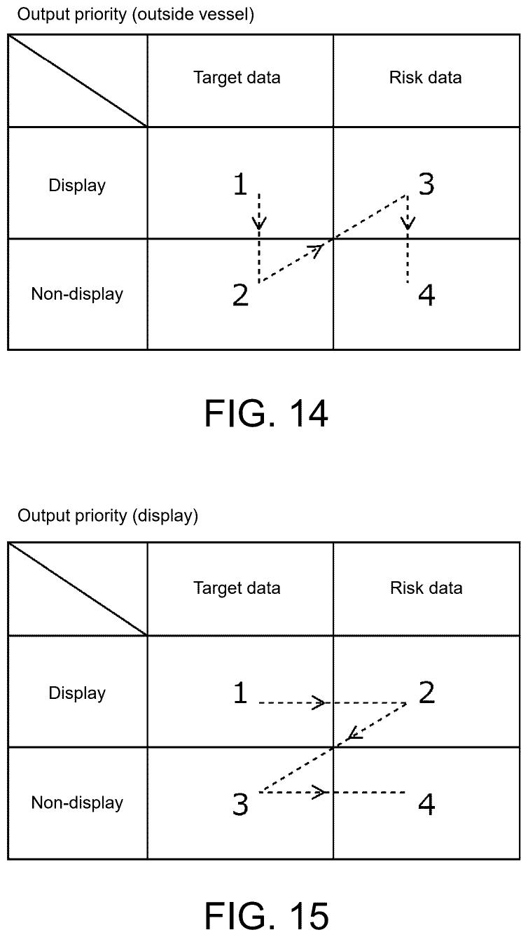

As shown in FIG. 14, in the case where the output destination is outside the own ship, the data output unit 17 sets the output priority in order from the highest: (1) the target data for the display target, (2) the target data for the non-display target, (3) the risk data related to the display target, and (4) the risk data related to the non-display target. This allows target data to be preferentially shared with onshore or other ship devices.

As shown in FIG. 15, in the case where the output destination is the display unit 2, the data output unit 17 sets the output priority in order from highest: (1) target data for the display target, (2) risk data related to the display target, (3) target data for the non-display target, and (4) risk data related to the non-display target. This prioritizes target data and risk data used for display.

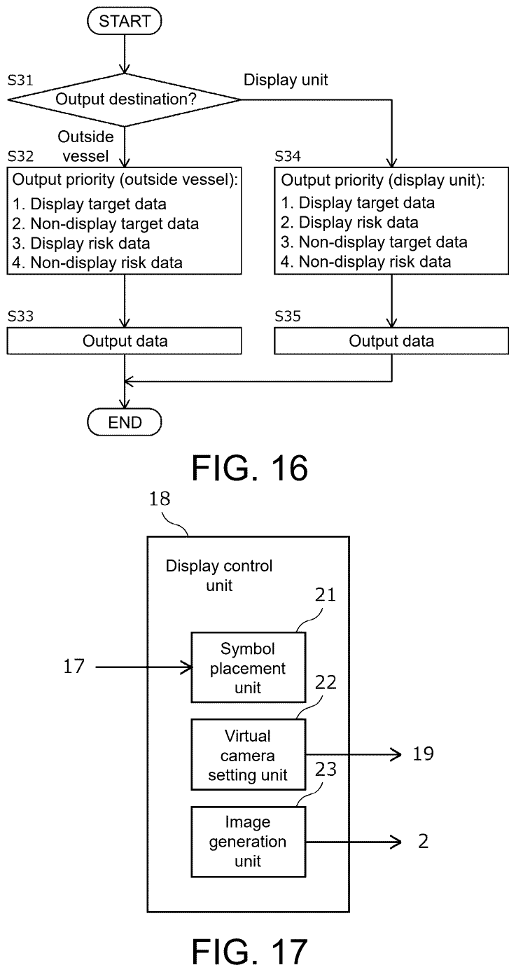

FIG. 16 is a diagram showing a procedure example of a radar information sharing method realized in the radar system 100. The processing circuitry 10 of the radar system 100 serves as the data output unit 17 by periodically executing the information processing shown in the figure according to a program.

First, the processing circuitry 10 determines whether the output destination is outside the own ship or the display unit 2 (S31).

In the case where the output destination is outside the own ship, the processing circuitry 10 sets the output priority in order from the highest: (1) target data for the display target, (2) target data for the non-display target, (3) risk data related to the display target, and (4) risk data related to the non-display target (S32, see FIG. 14), and sequentially outputs the target data and the risk data (S33).

On the other hand, in the case where the output destination is the display unit 2, the processing circuitry 10 sets the output priority in order from the highest: (1) target data for the display target, (2) risk data related to the display target, (3) target data for the non-display target, and (4) risk data related to the non-display target (S34, see FIG. 15), and sequentially outputs the target data and the risk data (S35).

With the above, a series of processing for data output is completed.

### Three-Dimensional Display

Hereinafter, an example of three-dimensional display performed by the display control unit 18 will be described. FIG. 17 is a diagram showing a configuration example of the display control unit 18. The display control unit 18 includes a symbol placement unit 21, a virtual camera setting unit 22, and an image generation unit 23.

FIG. 18 is a diagram showing an example of a virtual three-dimensional space VS. The virtual three-dimensional space VS has a coordinate system corresponding to the real space. FIG. 19 is a diagram showing an example of a three-dimensional image DMG generated by the display control unit 18.

The symbol placement unit 21 places the own ship symbol BB at a position on a virtual water surface VF of the virtual three-dimensional space VS corresponding to the actual position of the own ship, based on the vessel data acquired by the ship data acquisition unit 11 (see FIG. 2). Additionally, the symbol placement unit 21 places the scheduled route RT and the waypoint WP of the own ship.

Additionally, the symbol placement unit 21 places the target symbol SB representing the display target at a position on the virtual water surface VF of the virtual three-dimensional space VS corresponding to the actual position of the display target, based on the target data of the display target generated by the target data generation unit 12 (see FIG. 2) and output by the data output unit 17.

In the example, the own ship symbol BB and the target symbol SB are configured by a three-dimensional object that imitates a ship hull. However, the invention is not limited thereto. The own ship symbol BB and the target symbol SB may also be a two-dimensional object such as a circle.

Additionally, the symbol placement unit 21 places the collision risk area OZ at a position on the virtual water surface VF of the virtual three-dimensional space VS corresponding to the actual position of the collision risk area, based on the risk data related to the display target calculated by the risk data calculation unit 15 (see FIG. 2) and output by the data output unit 17.

The symbol placement unit 21 may display a target symbol SB of a display target having a collision risk equal to or above a particular level with the own ship, such as the target symbol SB having the collision risk area OZ, in a distinguishable manner from other target symbols SB. The distinguishable display is performed by, for example, a differentiating color, shape, or texture.

The virtual camera setting unit 22 sets a virtual camera VC in the virtual three-dimensional space VS. The virtual camera setting unit 22 sets the virtual camera VC at a particular relative position with respect to the own ship symbol BB. Additionally, the virtual camera setting unit 22 moves the virtual camera VC in accordance with the movement of the own ship symbol BB.

The display target range identification unit 19 identifies a display target range corresponding to a field of view ES of the virtual camera VC. When the display target range is identified, the target selection unit 16 selects a target included in the display target range as a display target, and the symbol placement unit 21 places the target symbol SB representing the display target in the virtual three-dimensional space VS.

Additionally, even for a target not currently included in the display target range, since target having a collision risk area corresponds to a target that will be included in the display target range in the future, the target selection unit 16 may also select such target as a display target.

The image generation unit 23 renders the scene within the field of view ES of the virtual camera VC in the virtual three-dimensional space VS to generate a three-dimensional image DMG. As shown in FIG. 19, the three-dimensional image DMG includes the own ship symbol BB, the target symbol SB, and the collision risk area OZ that are present within the field of view ES of the virtual camera VC.

The three-dimensional image DMG includes a button B1 for switching the virtual camera VC to bird view mode, a button B2 for switching to top view mode, and a button B3 for switching to bridge view mode.

Additionally, the three-dimensional image DMG includes a button B4 for resetting the viewpoint position of the virtual camera VC, a button B5 for advancing the viewpoint position, and a button B6 for retreating the viewpoint position.

Additionally, the three-dimensional image DMG includes a button B7 for increasing the magnification ratio of the virtual camera VC, a button B8 for decreasing the magnification ratio, and a button B9 for switching between north-up display and head-up display.

The virtual camera setting unit 22 switches the virtual camera VC to the bird view mode, the top view mode, or the bridge view mode in response to the user operation input to the buttons B1 to B3. The display target range identification unit 19 updates the display target range according to the mode switching of the virtual camera VC.

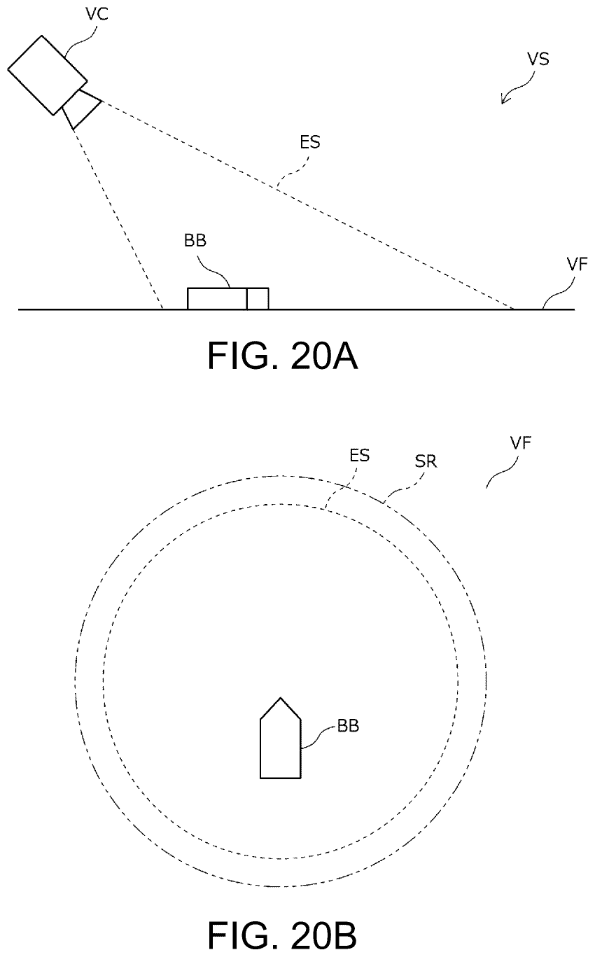

FIG. 20A and FIG. 20B are a side view and a plan view showing an example in when the virtual camera VC is set to the bird view mode. In the bird view mode, the virtual camera VC is set to look down diagonally at the own ship symbol BB toward the traveling direction of the own ship symbol BB.

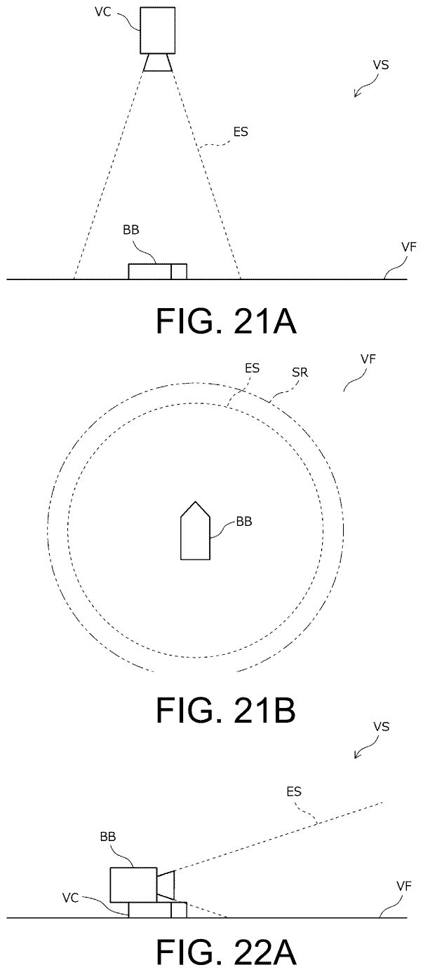

FIG. 21A and FIG. 21B are a side view and a plan view showing an example when the virtual camera VC is set to the top view mode. In top view mode, the virtual camera VC is set to look down directly at the own ship symbol BB from above.

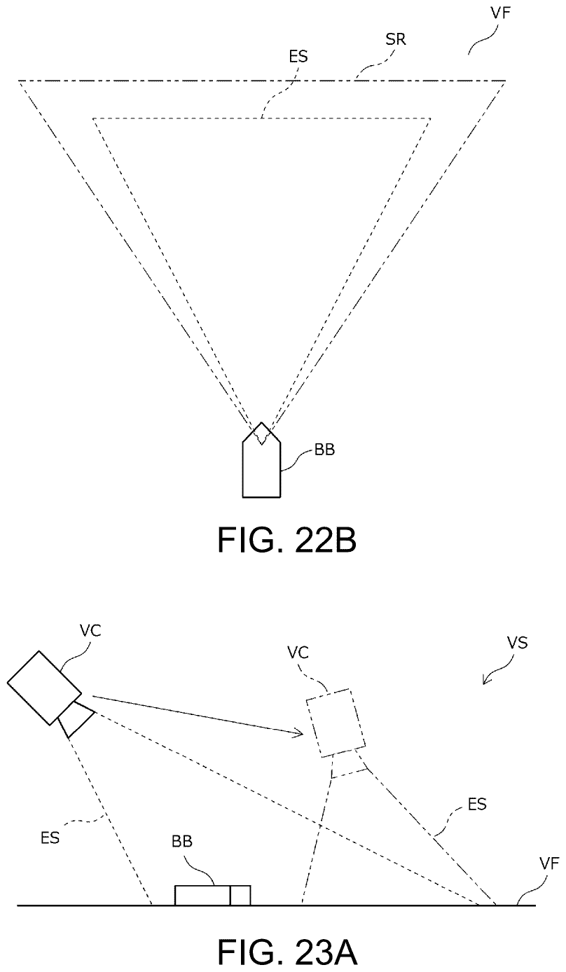

FIG. 22A and FIG. 22B are a side view and a plan view showing an example when the virtual camera VC is set to the bridge view mode. In bridge view mode, the virtual camera VC is set to view the virtual water surface VF from a height corresponding to the wheelhouse of the own ship symbol BB.

The actual range corresponding to a range SR that includes the portion of the field of view ES of the virtual camera VC on the virtual water surface VF and the surroundings thereof is identified as the display target range. By making not only the field of view ES of the virtual camera VC but also the surroundings correspond to the display target range, the target symbol SB can be placed in advance in the direction where the field of view ES of the virtual camera VC moves.

The virtual camera setting unit 22 moves the virtual camera VC according to the movement of the own ship symbol BB. Specifically, the virtual camera setting unit 22 causes the virtual camera VC to follow the own ship symbol BB, such that the relative position and posture with respect to the own ship symbol BB are maintained. The display target range identification unit 19 updates the display target range according to the movement of the virtual camera VC.

The virtual camera setting unit 22 may change the position, the orientation, the viewing angle, or the magnification ratio of the virtual camera VC in response to user operation input to the buttons B1 to B6 or the touch panel (see FIG. 23A and FIG. 23B). The display target range identification unit 19 updates the display target range according to changes in the position, etc., of the virtual camera VC.

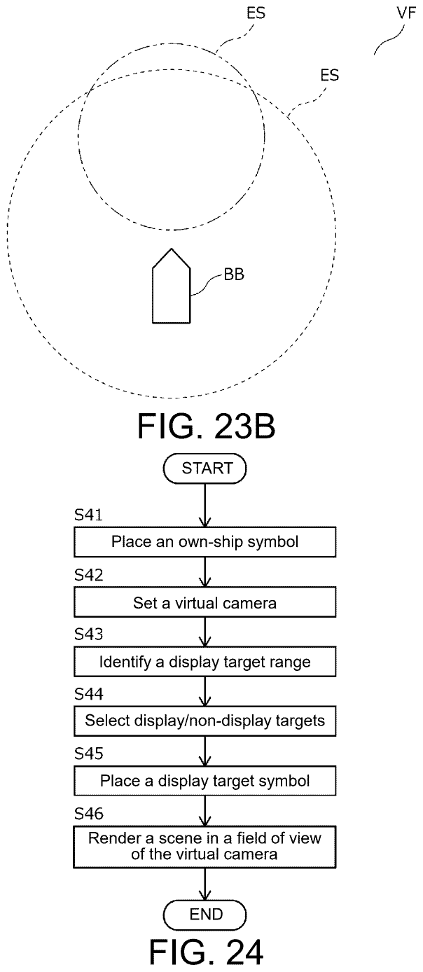

FIG. 24 is a diagram showing a procedure example of a radar display method realized in the radar system 100. The processing circuitry 10 of the radar system 100 periodically executes the information processing shown in the figure according to a program.

First, the processing circuitry 10 places the own ship symbol BB at a position on the virtual water surface VF of the virtual three-dimensional space VS corresponding to the actual position of the own ship (S41, a process as the symbol placement unit 21).

Next, the processing circuitry 10 sets the virtual camera VC in the virtual three-dimensional space VS (S42, a process as the virtual camera setting unit 22).

Next, the processing circuitry 10 identifies the display target range corresponding to the field of view ES of the virtual camera VC (S43, a process as the display target range identification unit 19).

Next, the processing circuitry 10 selects a target included in the display target range as the display target from among the targets present around the own ship (S44, a process as the target selection unit 16).

Next, the processing circuitry 10 places the target symbol SB of the display target at a position on the virtual water surface VF of the virtual three-dimensional space VS corresponding to the actual position of the display target (S45, a process as the symbol placement unit 21).

Next, the processing circuitry 10 renders the scene within the field of view ES of the virtual camera VC in the virtual three-dimensional space VS to generate the three-dimensional image DMG (S46, a process as the image generation unit 23).

The processing circuitry 10 repeatedly executes the series of processes described above while updating the positions of the own ship symbol BB, the target symbol SB, and the virtual camera VC.

Although the embodiments of the invention have been described above, the invention is not limited to the embodiments described above, and it is obvious that various modifications are possible for those skilled in the art.

In the above embodiment, the display unit 2 is connected to the processing circuitry 10, and the display unit 2 displays the image generated by the display control unit 18. However, the invention is not limited to this, and a device including the display unit 2 and the display control unit 18 may be provided separately from the processing circuitry 10 and may receive supply of target data and risk data from the processing circuitry 10 through a communication network.

In the above embodiment, the radar system 100 is mounted on a ship. However, the invention is not limited to this, and the radar system 100 may be installed on land. In the case where multiple ships are present in the region where the radar sensor 1 emits radio waves, risk data and the like can be calculated by designating one ship as “ship” and other ships as “targets.”

The embodiments of the invention have been described above, but the invention is not limited to the embodiments described above, and it is obvious that various modifications are possible for those skilled in the art.

Exemplary embodiments of the invention are listed below.
(1) A radar system includes: a radar sensor, receiving reflected waves of radio waves generated around a vessel and generating echo data; a generation unit, generating target data including a position and a velocity of a target present around the vessel based on the echo data; a selection unit, selecting a display target and a non-display target from among the target; and an output unit, setting an output priority of target data of the display target over an output priority of target data of the non-display target, and outputting the target data.
(2) The radar system according to (1) further includes: an acquisition unit, acquiring vessel data including a velocity of the vessel; and a calculation unit, calculating risk data representing a risk that the vessel collides with the target based on the vessel data and the target data. The output unit sets an output priority of risk data related to the display target over an output priority of risk data related to the non-display target and outputs the risk data that are sequentially calculated.
(3) In the radar system according to (2), the output unit changes the output priorities of the target data of the display target, the target data of the non-display target, the risk data related the display target, and the risk data related to the non-display target according to a type of an output destination.
(4) In the radar system according to (2) or (3), the output unit switches the output priority of the target data of the non-display target and the output priority of the risk data related to the display target according to a type of an output destination.
(5) In the radar system according to any one of (2) to (4), in a case where an output destination is outside the vessel, the output unit sets in order, from a highest output priority, the target data of the display target, the target data of the non-display target, the risk data related to the display target, and the risk data related to the non-display target.
(6) In the radar system according to any one of (2) to (5), in a case where an output destination is a display unit provided at the vessel, the output unit sets in order, from a highest output priority, the target data of the display target, the risk data related to the display target, the target data of the non-display target, and the risk data related to the non-display target.
(7) In the radar system according to (6), the display unit displays a velocity symbol representing a velocity of the display target and a collision risk area related to the display target.
(8) In the radar system according to (6) or (7), the output unit sets an output frequency of data with a low output priority to be lower than an output frequency of data with a high output priority.
(9) In the radar system according to any one of (6) to (8), the output unit sets a compression ratio of data with a low output priority to be higher than a compression ratio of data with a high output priority.
(10) In the radar system according to any one of (2) to (9), the selection unit selects, as the display target, a target whose risk of collision is equal to or higher than a particular level based on the risk data.
(11) The radar system according to any one of (1) to (10) further includes: an identification unit, identifying a display target range displayed in the image. The selection unit selects, as the display target, a target included in the display target range.
(12) In the radar system according to any one of (1) to (11), the selection unit selects, as the display target, a target instructed by a user.
(13) A radar information sharing method includes: generating echo data by using radar sensor receiving reflected waves of radio waves generated around a vessel; generating target data including a position and a velocity of a target present around the vessel based on the echo data; selecting a display target and a non-display target from among the target; and setting an output priority of target data of the display target over an output priority of target data of the non-display target, and outputting the target data.
(14) A, program is provided to cause a computer to execute: generating echo data by using a radar sensor receiving reflected waves of radio waves generated around a vessel; generating target data comprising a position and a velocity of a target present around the vessel based on the echo data; selecting a display target and a non-display target from among the target; and setting an output priority of target data of the display target over an output priority of target data of the non-display target, and outputting the target data.

### Expressions

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processor. A processor can be a microprocessor, but in the alternative, the processor can be a controller, microcontroller, or state machine, combinations of the same, or the like. A processor can include electrical circuitry configured to process computer-executable instructions. In another embodiment, a processor includes an application specific integrated circuit (ASIC), a field programmable gate array (FPGA) or other programmable device that performs logic operations without processing computer-executable instructions. A processor can also be implemented as a combination of computing devices, e.g., a combination of a digital signal processor (DSP) and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C. The same holds true for the use of definite articles used to introduce embodiment recitations. In addition, even if a specific number of an introduced embodiment recitation is explicitly recited, those skilled in the art will recognize that such recitation should typically be interpreted to mean at least the recited number (e.g., the bare recitation of “two recitations,” without other modifiers, typically means at least two recitations, or two or more recitations).

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.).

For expository purposes, the term “horizontal” as used herein is defined as a plane parallel to the plane or surface of the floor of the area in which the system being described is used or the method being described is performed, regardless of its orientation. The term “floor” can be interchanged with the term “ground” or “water surface”. The term “vertical” refers to a direction perpendicular to the horizontal as just defined. Terms such as “above,” “below,” “bottom,” “top,” “side,” “higher,” “lower,” “upper,” “over,” and “under,” are defined with respect to the horizontal plane.

As used herein, the terms “attached,” “connected,” “mated,” and other such relational terms should be construed, unless otherwise noted, to include removable, moveable, fixed, adjustable, and/or releasable connections or attachments. The connections/attachments can include direct connections and/or connections having intermediate structure between the two components discussed.

Numbers preceded by a term such as “approximately”, “about”, and “substantially” as used herein include the recited numbers, and also represent an amount close to the stated amount that still performs a desired function or achieves a desired result. For example, the terms “approximately”, “about”, and “substantially” may refer to an amount that is within less than 10% of the stated amount. Features of embodiments disclosed herein preceded by a term such as “approximately”, “about”, and “substantially” as used herein represent the feature with some variability that still performs a desired function or achieves a desired result for that feature.

It should be emphasized that many variations and modifications may be made to the above-described embodiments, the elements of which are to be understood as being among other acceptable examples. All such modifications and variations are intended to be included herein within the scope of this disclosure and protected by the following claims.

What is claimed is:

1. A radar system, comprising:
processing circuitry, configured to:
receive reflected waves of radio waves generated around a vessel and generate echo data;
generate target data comprising a position and a velocity of a target present around the vessel based on the echo data;
select a display target and a non-display target from among the target; and
set an output priority of target data of the display target over an output priority of target data of the non-display target, and output the target data.

2. The radar system as claimed in claim 1, wherein the processing circuitry is further configured to:
acquire vessel data comprising a velocity of the vessel; and
calculate risk data representing a risk that the vessel collides with the target based the vessel data and the target data; and
set an output priority of risk data related to the display target over an output priority of risk data related to the non-display target and output the risk data that are sequentially calculated.

3. The radar system as claimed in claim 2, wherein the processing circuitry is further configured to: change the output priorities of the target data of the display target, the target data of the non-display target, the risk data related the display target, and the risk data related to the non-display target based on a type of an output destination.

4. The radar system as claimed in claim 2, wherein the processing circuitry is further configured to: switch the output priority of the target data of the non-display target and the output priority of the risk data related to the display target according to a type of an output destination.

5. The radar system as claimed in claim 2, wherein, in a case where an output destination is outside the vessel, the processing circuitry is further configured to: set, in order from a highest output priority, the target data of the display target, the target data of the non-display target, the risk data related to the display target, and the risk data related to the non-display target.

6. The radar system as claimed in claim 2, wherein, in a case where an output destination is a display unit provided at the vessel, the processing circuitry is further configured to: set, in order from a highest output priority, the target data of the display target, the risk data related to the display target, the target data of the non-display target, and the risk data related to the non-display target.

7. The radar system as claimed in claim 6, wherein the display unit displays a velocity symbol representing a velocity of the display target and a collision risk area related to the display target.

8. The radar system as claimed in claim 6, wherein the processing circuitry is further configured to: set an output frequency of data with a low output priority to be lower than an output frequency of data with a high output priority.

9. The radar system as claimed in claim 6, wherein the processing circuitry is further configured to: set a compression ratio of data with a low output priority to be higher than a compression ratio of data with a high output priority.

10. The radar system as claimed in claim 2, wherein the processing circuitry is further configured to: select, as the display target, a target whose risk of collision is equal to or higher than a particular level based on the risk data.

11. The radar system as claimed in claim 1, wherein the processing circuitry is further configured to: identify a display target range displayed in the image; and
select, as the display target, a target included in the display target range.

12. The radar system as claimed in claim 1, wherein the processing circuitry is further configured to: select, as the display target, a target instructed by a user.

13. A radar information sharing method, comprising:
generating echo data by using a radar sensor receiving reflected waves of radio waves generated around a vessel;
generating target data comprising a position and a velocity of a target present around the vessel based on the echo data;
selecting a display target and a non-display target from among the target; and
setting an output priority of target data of the display target over an output priority target data of the non-display target, and outputting the target data.

14. A non-transitory computer readable medium, storing a program, the program causing a computer to execute:
generating echo data by using a radar sensor receiving reflected waves of radio waves generated around a vessel;
generating target data comprising a position and a velocity of a target present around the vessel based on the echo data;
selecting a display target and a non-display target from among the target; and
setting an output priority of target data of the display target over an output priority target data of the non-display target, and outputting the target data.
